(19) United States
(12) Patent Application Publication
(10) Pub. No.: US 2024/0396913 A1
(43) Pub. Date: Nov. 28, 2024

(54) SEQUENTIAL PACKETS IMAGE-BASED NETWORK INTRUSION DETECTION SYSTEM

(71) Applicant: UNIVERSITY OF SOUTH FLORIDA, Tampa, FL (US)

(72) Inventors: Ankit SHAH, Tampa, FL (US); Jalal GHADERMAZI, Tampa, FL (US)

(21) Appl. No.: 18/673,231

(22) Filed: May 23, 2024

Related U.S. Application Data
(60) Provisional application No. 63/503,794, filed on May 23, 2023.

(51) Int. Cl. H04L 9/40; H04L 41/16

(52) U.S. Cl. CPC H04L 63/1425; H04L 41/16; H04L 63/1416

(57) ABSTRACT

The disclosed technology provides a method for detecting malicious activity in a network communication system. A first packet of a first flow is received from the network communication system. The first packet comprises a first sequence of data values. The first sequence of data values is converted to a first plurality of pixel image attribute values. A first portion of an image is generated based on the first plurality of pixel image attribute values. The image is processed using a trained neural network model to determine a likelihood of malicious activity in the first flow.

### CROSS-REFERENCE TO RELATED APPLICATION(S)

This application claims the benefit of U.S. Provisional Patent Application Ser. No. 63/503,794, filed May 23, 2023, the disclosure of which is hereby incorporated by reference in its entirety.

### STATEMENT REGARDING FEDERALLY SPONSORED RESEARCH

N/A

### BACKGROUND

Machine learning (ML) and deep learning (DL) advancements show promise for use in performing anomaly detection tasks within network intrusion detection systems (NIDS), given that ML and DL algorithms are useful for processing large amounts of data and extracting patterns. However, proposed uses of ML/DL within NIDS contemplate only models that would be trained using either flow-based or packet-based features. Flow-based NIDS are suitable for offline traffic analysis, while packet-based NIDS can analyze traffic and detect attacks in real-time. However, currently-contemplated packet-based approaches would only analyze packets independently, while overlooking the sequential nature of network communication. Thus, the inventors have found that these approaches result in biased models that exhibit increased false negatives and positives. Additionally, most packet-based NIDS capture only payload data, neglecting crucial information from packet headers. This oversight can impair the ability to identify header-level attacks, such as denial-of-service attacks.

Therefore, it would be desirable to have systems and methods that leverage the powerful data analysis features of ML and DL algorithms, while still having a high degree of accuracy and utilizing all available information that can be gleaned from network traffic.

### SUMMARY

The following presents a simplified summary of one or more aspects of the present disclosure, to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some aspects, the present disclosure can provide a method for detecting malicious activity in a network communication system. A first packet of a first flow can be received from the network communication system. The first packet can include a first sequence of data values. The first sequence of data values can be converted to a first plurality of pixel image attribute values. A first portion of an image can be generated based on the first plurality of pixel image attribute values. The image can be processed using a trained neural network model to determine a likelihood of malicious activity has been detected.

In some examples, the method can further include generating a notification indicating that malicious activity has been detected.

In some examples, the method can further include determining if there are additional packets in the first flow. A second packet of the first flow can be received from the network communication system. The second packet can include a second sequence of data values. The second sequence of data values can be converted to a second plurality of pixel image attribute values. A second portion of the image can be generated based on the second plurality of pixel image attribute values. The image can be processed using the trained neural network model to determine an updated likelihood of malicious activity in the first flow, corresponding to the first packet and the second packet.

In some examples, the first plurality of pixel image attribute values is a first plurality of red-green-blue (RGB) values. The second plurality of pixel image attribute values can be a second plurality of RBG values. The second plurality of RGB values can be different from the first plurality of RGB values.

In some examples, the first packet from the network communication system can be an incoming packet.

In some examples, the second packet from the network communication system can be an outgoing packet.

In some examples, the first sequence of data values can include at least one hexadecimal byte value.

In some examples, converting the first sequence of data values to the first plurality of pixel image attribute values can include converting the at least one hexadecimal byte value to at least one decimal value. A corresponding color scale value can be assigned to the at least one decimal value.

In some aspects, the present disclosure can provide a system for detecting malicious activity in a network communication system. The system can include one or more processors and a memory in communication with the processor and having instruction stored thereon. A first packet of a first flow is received from the network communication system. The first packet can include a first sequence of data values. The first sequence of data values can be converted to a first plurality of pixel image attributes values. A first portion of an image can be generated based on the first plurality of pixel image attribute values. The image can be processed using a trained neural network model to determine a likelihood of malicious activity in the first flow.

These and other aspects of the disclosure will become more fully understood upon a review of the drawings and the detailed description, which follows. Other aspects, features, and embodiments of the present disclosure will become apparent to those skilled in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. Similarly, while example embodiments may be discussed below as devices, systems, or methods embodiments it should be understood that such example embodiments can be implemented in various devices, systems, and methods.

### BRIEF DESCRIPTION OF THE DRAWINGS

FIG. 1 is a flow diagram illustrating an example process for detecting malicious activity in network communications according to some embodiments.

FIG. 2 is a block diagram conceptually illustrating a system for detecting malicious activity in network communications according to some embodiments.

FIG. 3 is a block diagram illustrating an example framework for a Sequential Packets Image-based Network Intrusion Detection System (SPIN-IDS) according to some embodiments.

FIG. 4 is a diagram illustrating example TCP/IP model layers with information byte details according to some embodiments.

FIG. 5 is a diagram illustrating an example representation of auxiliary and packet-based features according to some embodiments.

FIG. 6 is a schematic of an example image builder processing showing the generation of the first two image in a flow according to some embodiments.

FIG. 7 illustrates three example image samples generated using image builder components with 15 sequential packets according to some embodiments.

FIG. 8 is example architecture of a CNN model for network intrusion detection according to some embodiments.

FIG. 9 illustrates example learning curves of an optimized model according to some embodiments.

FIG. 10 is an example visual of model performance of different image representations according to some embodiments.

FIG. 11 is an example plot illustrating PSNR scores for different image representations of various attack types compared to benign traffic according to some embodiments.

FIG. 12 is an example plot illustrating recall scores for different image representations of various attack types.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts, and embodiments described herein may be implemented and practiced without these specific details. In some instances, well-known structures and components are shown in block diagram form to avoid obscuring such concepts.

The present disclosure provides for improved implementations of intrusion detection systems (IDS). IDS are designed to monitor and identify attacks on organizations' computer and network systems. They can be classified into host-based IDS (HIDS) and network-based IDS (NIDS). NIDS are advantageous for detecting attacks in large organizations, since they can be configured to analyze the network traffic of various ‘nodes’ within the network (such as nodes that might be deemed ‘critical’ points by an attacker) to identify attack behavior, as opposed to monitoring a single node in HIDS.

The detection strategies used in NIDS include signature-based and anomaly-based methods. Signature-based methods can operate through processes involving creating domain-specific rules; anomaly-based methods can employ machine learning (ML) and deep learning (DL) algorithms and train on big data to identify patterns that may indicate a likelihood ofmalicious behavior.

In a certain regard, ML/DL-enabled NIDS can trained using either or both of at least two forms of data constructs: they can be trained using either of the two types of features (or data constructs) generally understood as being extracted from network traffic data: flow-based or packet-based. Flow-based analyses aggregate information from the packet headers in network communications together with the payloads of those packets, while packet-based features are extracted directly from the packet data.

There are certain design challenges and criteria that must be overcome when considering how to improve on basic formats of flow-based NIDS. A very basic flow-based NIDS might encounter the following obstacles which would need

to be overcome (and, in fact, are overcome by the embodiments disclosed herein): (i) conceptually, they would analyze traffic once the flow between the sender and receiver is completed, to identify any malicious activity, making them suitable for offline network traffic analysis or or at best not a rapid, real time analysis in comparison to the rate packets are received; (ii) following existing notions, they would mainly extract features from lower levels of the transmission control protocol (TCP)/internet protocol (IP) model, making it challenging to detect higher-level attacks that target the application layer. For example, a distributed denial-of-service (DDOS) attack such as SYN floods targets with network packet header data, whereas a SQL injection attack injects anomalous code into the SQL queries (i.e., at a packet payload level); (iii) they identify attacks based on extracted flow features, which do not capture the functional behavior of network traffic in the packets; (iv) with different ways of extracting flow-based features, including the use of CIC Flowmeter and Zeck (Bro), the feature set used to train the intrusion detection models also varies among different network environments, making it difficult to benchmark the trained model's performance in a new target environment (domain adaptability).

Packet-based NIDS, on the other hand, are more suitable for real-time detection as features are extracted directly from the packet data. However, there are also challenges with the packet-based approach. Considering a basic packet based NIDS, obstacles that may need to be addressed include: (i) Categorizing packets as benign or malicious is non-trivial. Not all packets have a malicious intent in an attack. For e.g., packets such as TCP three-way handshakes represent normal network characteristics in both benign as well as malicious traffic. (ii) A pure packet-by-packet based NIDS would not consider the sequential functioning of packets in a flow and instead treat them as independent packets. As a result, the temporal correlations among the packets belonging to the flows are not captured, which may result in an incorrect classification by the NIDS (iii) They do not consider the direction of packets due to independence assumptions. However, the direction of a packet in a flow (forward or backward) can provide significant information in identifying attacks. For instance, network attacks like Distributed Denial-of-Service (DDoS) and Port Scan often exhibit substantial differences in forward and backward packet patterns compared to normal traffic.

The following description addresses how various novel systems and mehtods can overcome these limitations in flow-based and packet-based approaches for a timely detection of network attacks. Some embodiments, therefore, are able to combine both these approaches to preserve the temporal-spatial association between packets and their features for prompt detection of different attacks on packet header and payload data. The methods may extract features from high-level and low-level packet information and utilize them together.

### Example Process

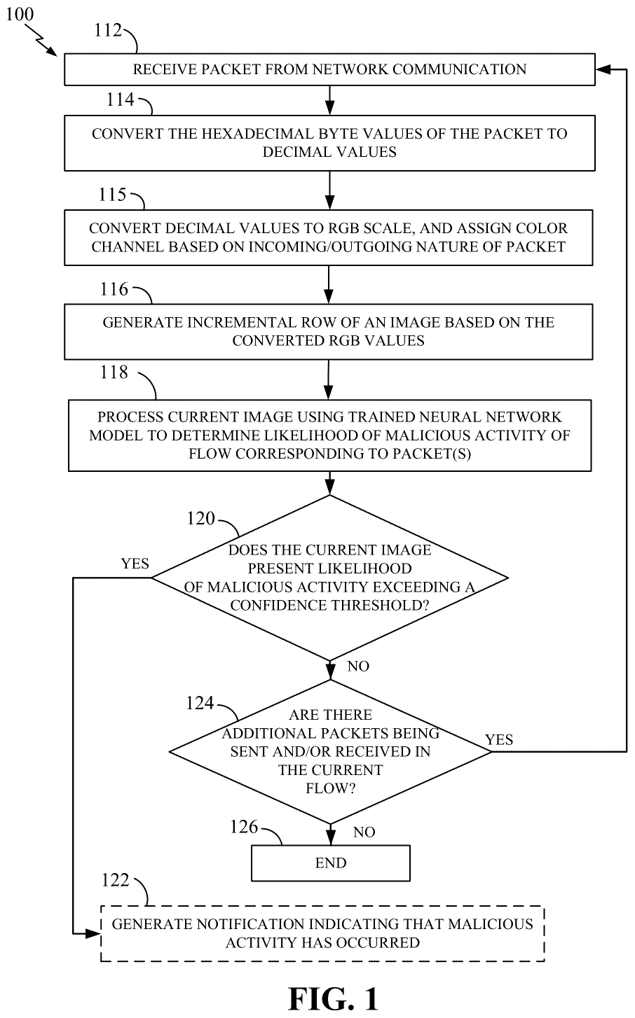

FIG. 1 is a flow diagram illustrating an example process 100 for detecting malicious activity in network communications in accordance with some aspects of the present disclosure. As described below, a particular implementation can omit some or all illustrated features/steps, may be implemented in some embodiments in a different order, and may not require some illustrated features to implement all embodiments. Thus, in the Examples section, certain specific details of example approaches within the scope of process 100 are set forth in detail, and serve to demonstrate the various ways in which process 100 can be configured and implemented.

Process 100 could be performed on one individual ‘flow’ or sequence of network traffic on an individual basis, or (in some cases more advantageously) can be performed on a continuous or semi-continuous basis to monitor ongoing network packet flows. And, process 100 can be performed on an enterprise basis at a network perimeter or firewall, or can be performed for a specific IP address or other endpoint device. As depicted, process 100 may be utilized to continuously monitor packet traffic.

At step 112, process 100 receives a packet from a network communication stream. The packet may be an incoming or outgoing packet (relative to the device or network being monitored by process 100), and may be part of a ‘flow’ of packets. For purposes of this particular discussion, a ‘flow’ of packets may be considered as sequence or set of packets representing a communication session between two IP addresses (or, considered otherwise, communication between two different devices on different networks, two devices on a common network, two endpoints, etc.). As a non-limiting example, the packets that comprise a ‘flow’ may include certain common characteristics such as source IP and destination IP (which may be in either ordering, depending on whether the packet is incoming or outgoing), source port and destination port (which, again, may be reversed depending on the directionality of a given packet), transport protocol, etc. In some contexts, a flow may be considered unidirectional communication (e.g., a website sending data to a requestor), but as discussed herein a ‘flow’ of packets may include both the incoming and outgoing packets representing the communication between the source and destination of that communication. By considering bi-directional traffic, additional information about potential malicious activity can be gleaned. Thus, process 100 can be used to monitor a unidirectional flow of only incoming packets, a unidirectional flow of only outgoing packets, or a flow comprising both incoming and outgoing packet traffic (which could also be considered as two interleaved flows representing one communication session). Similarly, it should be noted that packets of many different flows may be arriving at the same network perimeter, firewall, IP address, and/or port, so process 100 may operate in a parallel fashion in which the steps of process 100 are simultaneously operating on multiple flows.

At step 114, process 100 may take the data of the received packet (including in some examples the full packet including the packet header) and convert the data into a data format amenable to generating an image. For example, a typical IP packet may include a header and payload, and the bytes of data forming the IP packet may be represented in hexadecimal format. The sequential bytes of data of the packet may be converted into, for example, digital (base 10) values or other values that may be utilized to define pixels (or similar attributes or portions) of an image.

At block 115 (which may be part of the same step) the converted data is scaled to be image data. In some embodiments, for example, the sequential hexadecimal values of the bytes in the IP packet may be converted to sequential decimal values, and then scaled and normalized to be represented as RGB color values of a given color channel on a scale of 0-255. In some embodiments, the sequential values of the bytes of data of the packet can be assigned sequential positions within a row of an image. For example, in the case of a typical RGB image, one IP packet may become a single-color row of an image in which each pixel of the row represents a 0-255 scaled color value corresponding to a hexadecimal value of the IP packet. It is contemplated, however, that other embodiments may utilize other image formats and schemes, such as CMYK, grayscale (wherein a given pixel, flag, or other identifier is used to indicate incoming/outgoing packet directionality), YUV/YCrCb, HSV, LAB, Indexed Color, YIQ, XYZ, etc.

In further embodiments, outgoing packet traffic of a given flow may be assigned one color channel (e.g., red) and incoming packet traffic of a given flow may be assigned another color channel (e.g., green). A third color channel may be reserved for additional information that can be taken into account, such as network intrusion information obtained from another source (e.g., knowledge of suspicious activity by a given IP address, such as possible scanning behavior; unusual number of concurrent or near-simultaneous flows being sent to/from a given IP address or port of a network, etc.). In other words, the numerical values forming the header and payload data of an IP packet can be converted into a format representing an attribute of an image (e.g., a color channel, intensity value, etc.)

At block 116, process 100 can convert the IP packet's color-encoded data into a row of an image. Each row of the ‘image’ may represent a packet, or each row of the image may represent a packet flow. In other embodiments a packet may be represented as a non-linear square, rectangle, or patch of an image. In some embodiments, the sequential information of the packets can be preserved by incrementally adding another row (or patch) in an ordered manner. Thus, the first packet of a flow may be the ‘top’ row of the matrix of the image, the second packet of the flow may be the next row of the image, the third packet of the flow may follow the second row, and so forth.

At block 118, the current image may be processed as an input to a neural network that has been trained to classify images of this type, as exhibiting a likelihood (or not) of malicious activity in the associated flow. (In another manner of expressing the output of such a neural network, the image may be processed to determine a confidence value representing the likelihood the flow exhibits malicious activity and/or a confidence value representing the likelihood the flow does not exhibit malicious activity). In some embodiments, the neural network may be a CNN or similar type of model useful for processing and classifying images. The image may be provided as the sole input to the neural network in the image's current state. In other words, in some embodiments, as each incremental row is added to the image, the updated/incremented image is again provided to the trained network for processing.

At block 120, the output of the neural network is determined and used to assess the next course of action of process 100. If the image (i.e., the packet traffic of the given flow up to this point) exhibits a likelihood of malicious activity, then process 100 may proceed to take preventative action, mitigate harm, and/or alert a human user or other application at block 122. For example, process 100 may trigger a quarantine of the flow, an instruction to block network traffic from the source/external IP address involved, a scan of the endpoint device associated with the local IP address, quarantining the endpoint device from intra-network communication or database access, or other measure. In other examples, the action taken by process 100 may also include storing the identified flow, the associated image, and/or the output of the neural network for future use. In yet further embodiments, process 100 may continue to collect and process packets of the given flow, for future informational purposes, despite having taken action to prevent or mitigate harm (e.g., a firewall that is processing the flow may quarantine the flow, but continue to record incoming packets, etc.).

If process 100 determines at block 120 that the current image does not reflect a likelihood of malicious activity, then process 100 may continue to accumulate packets of the flow, increment the associated image, and reprocess the incremented image via the neural network until the end of the flow. In other embodiments, process 100 may include settings or configurations that eliminate unnecessary processing and will not continue to accumulate and process further packets of the flow. For example, if a high confidence level that the flow is not related to malicious activity is output by the neural network (e.g., near 100%, or above a given threshold such as above 85%, 90%, 95%, 96%, 97%, 98%, 99%, etc.—or any other user preference) then process 100 may simply avoid further use of computational resources to run the neural network on further packets of that flow. In yet further embodiments, process 100 may be configured to only exit the processing early if a given number of packets have already been processed (e.g., the process will exit if a high degree of likelihood of no malicious activity is determined after the 3rd, 4th, 5th, 6th, 7th, 8th, etc. packet).

For process 100, the CNN model may be custom built, such that its parameters are selected, configured, and trained to achieve best and most optimized state and high accuracy. Thus, with respect to certain of the examples described herein, it should be understood that a specific configuration of a CNN could be modified or replaced this with alternative CNN architectures featuring, for example, different numbers of layers, etc. Another potential alternative involves utilizing pre-trained models such as GoogleNet, EfficientNet, and others for feature extraction in the initial layers. However, since the images generated in process 100 are from raw data (i.e., they are not images of real world objects, intentional designs, etc.—they are instead merely sequences of color-coded pixels), employing pre-trained CNNs or other models in a way that leverages transfer learning methods may not be optimal, as they may not be as effective in this specific context.

In one example, the CNN classifier may be trained using various architectures with different numbers of convolutional layers and normalization techniques. The inventors developed embodiments having architectures ranging from shallow (one convolutional layer) to deep (seven convolutional layers) configurations, alongside diverse padding and stride strategies. Additionally, the inventors developed embodiments with different pooling layer strategies, including maximum and average pooling, to identify the most effective architecture.

For example, one advantageous CNN architecture for a two-color channel embodiment may comprise four convolutional layers (for example, defined as Conv2D), four max pooling layers (e.g., MaxPooling2D), one batch normalization layer following the first max pooling layer, two dropout layers, a flatten layer, and a dense layer for classification. In this example, the convolutional layers employed a same padding strategy to ensure the output image size matched the input size, with the stride set to the default value of (1,1). A batch normalization layer can be incorporated after the first pooling layer to enhance learning speed and stability. To mitigate overfitting, the inventors included two dropout layers with a dropout rate of 20% during training in this example. Given that this particular example embodiment of the CNN model was designed for binary classification (benign or malicious), a Binary Cross-entropy was used as the loss function and a Sigmoid activation function was utilized in the final dense layer to produce output values in the range of [0,1]. However, where other numbers of output channels are desired e.g., one output channel, three output channels, etc.), there could be use of a different loss function and/or a different activation function.

In another example, a unique optimization of hyperparameters of the layers, such as the activation function, kernel initializer, filter size, kernel size for each layer (e.g., each Conv2D layer), the number of units in the dense layer, batch size, optimizer method, and learning rate can be performed using training data that is specific to the type of network that will be monitored and the number of input channels that will be used (e.g., only incoming packets, incoming and outgoing packets, and/or use of additional data relevant to suspected malicious activity). This optimization can be conducted using various tools, such as for example the KerasTuner and TensorBoard tools, to leverage training and validation datasets to fine-tune the parameters.

In some examples, the CNN may be trained using a set of training data comprising network packet flows that have been labeled as indicative of malicious or benign activity, with two output channels (e.g., indicative of a confidence level of “malicious” classification and a confidence level of “non-malicious” classification). In further embodiments, the training data may comprise supplementary labels, allowing the CNN to provide classification beyond the binary labels of benign or malicious. For example, labels containing intrusion information beyond merely the information of a packet flow (e.g., obtained external to the data packets themselves) may be used to label training images, such as knowledge of malicious activity by a given IP address, (e.g., possible scanning behavior); unusual number of concurrent or near-simultaneous flows being sent to/from a given IP address or port of a network; other packet information corresponding to attributes known to be associated with malicious conduct, etc., These labels may be leveraged to improve accuracy of a binary output system, or may be used to predict a third output channel.

The CNN can also be trained using labeled images that represent full communication flows. Thus, for example, a complete image having rows representative of all packets in a flow may be labeled and used as one training image. In other examples, one flow of packets may be modified and duplicated to generate an augmented training set. As an example, if a training flow that is labeled as malicious has ten packets, it could be used to generate anywhere from one to ten training images for an augmented set that can be labeled as malicious. One of the augmented training images may include only a row representing the first packet, but still labeled as malicious; another training image may include only the first two rows of the packet, but still labeled as malicious, benign, or a combination of both.

In some examples, the CNN can also be set to be retrained using recently acquired communication flows. In particular, the retraining of the CNN may occur when a threshold number of confirmed flow analyses has been verified; a “confirmed” flow analysis may be an analysis (e.g., process 100) that ran until at least a specified amount of packets was acquired for a given flow and the flow was positively identified (e.g., above a high threshold of accuracy, and/or via user confirmation) as malicious or benign.

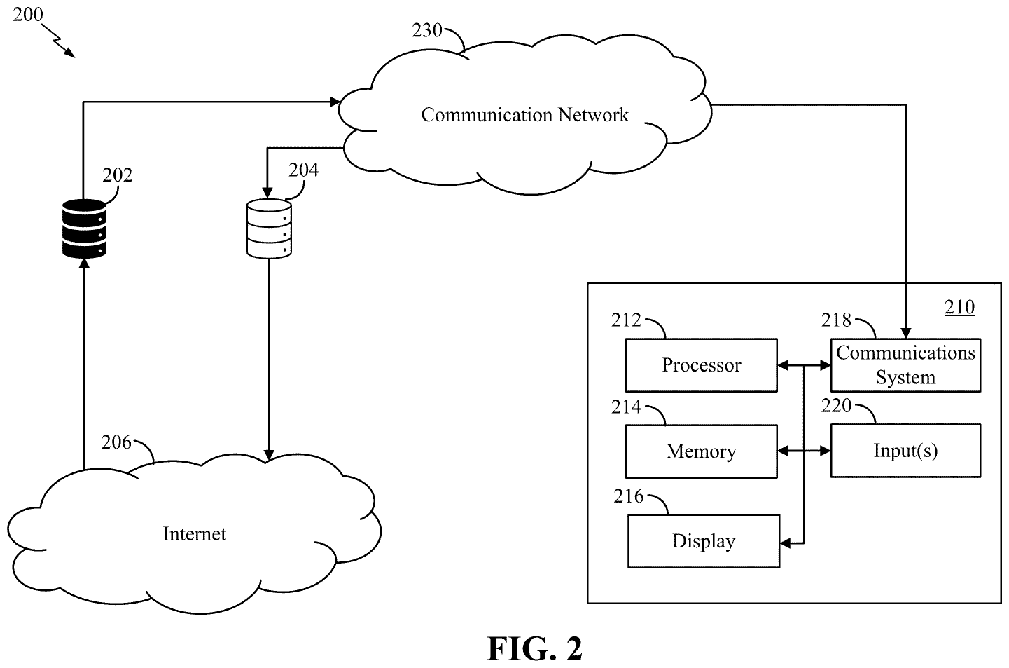

In some examples, an apparatus (e.g., processor 212 with memory 214) in connection with FIG. 2 can be used to perform example process 100. However, it should be appreciated that any suitable apparatus or means for carrying out the operations or features described below may perform process 100.

### Example Network Intrusion Detection System

FIG. 2 shows a block diagram illustrating a system for detecting malicious activity in network communications according to some embodiments. As shown in FIG. 2, computing device 210 can obtain or receive packets and packet data 202, 204, generate rows on an image based on each packet, and determine the likelihood of malicious activity based on the image. In some embodiments, computing device 210 may be a device configured to operate as a network perimeter device, a firewall device, a local network server, a router, an individual workstation, a mobile device, or any other Internet-connected device.

In some examples, computing device 210 can include a processor 212. In some embodiments, the processor 212 can be any suitable hardware processor or combination of processors, such as a central processing unit (CPU), a graphics processing unit (GPU), an application specific integrated circuit (ASIC), a field-programmable gate array (FPGA), a digital signal processor (DSP), a microcontroller (MCU), etc.

In further examples, computing device 210 can further include a memory 214. The memory 214 can include any suitable storage device or devices that can be used to store suitable data (e.g., packet header data, payload data, etc.), software instructions, the trained CNN, and other software aspects utilized by process 100. In other embodiments, there may be more than one memory, and the software instructions, trained CNN, and/or packet data may be stored in different memories. For example, the software instructions stored on memory 214 may be run by the processor 212 to cause the processor to receive packets from a network communication (e.g., enterprise-wide packet traffic at a firewall, local network traffic, or packet traffic at a given IP address or port); optionally convert hexadecimal (or other format) byte values of each packet to decimal values (or other format suitable for conversion to an image attribute); convert decimal values to RGB scale (or other image format) and assign a color channel (or other image attribute) based on the incoming/outgoing nature of each packet; generate an incremental row of an image based on the converted RGB values; and process the image using a trained neural network model to determine the likelihood of the malicious activity of flow corresponding to the packets. The memory 214 can include any suitable volatile memory, non-volatile memory, storage, or any suitable combination thereof. For example, memory 214 can include random access memory (RAM), read-only memory (ROM), electronically-erasable programmable read-only memory (EEPROM), one or more flash drives, one or more hard disks, one or more solid state drives, one or more optical drives, etc. In some embodiments, the processor 212 can execute at least a portion of process 100 described above in connection with FIG. 1.

In further examples, computing device 210 can further include communications system 218. Communications system 218 can include any suitable hardware, firmware, and/or software for communicating information over communication network 240 and/or any other suitable communication networks. For example, communications system 218 can include one or more transceivers, one or more communication chips and/or chip sets, etc. In a more particular example, communications system 218 can include hardware, firmware and/or software that can be used to establish a Wi-Fi connection, a Bluetooth connection, a cellular connection, an Ethernet connection, etc.

In further examples, computing device 210 can receive or transmit network communication information (e.g., bidirectional packet data flow(s) 202, 204); additional or external data corresponding to malicious activity of packets (e.g., information from a threat reporting service); a result of the likelihood of malicious, such as a notification or sequestration instruction, etc.; and/or any other suitable information over a communication network 230. In some examples, the communication network 230 can be any suitable communication network or combination of communication networks. For example, the communication network 230 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 230 can be a local area network, a wide area network, a public network (e.g., the Internet), a private or semi-private network (e.g., a corporate or university intranet), any other suitable type of network, or any suitable combination of networks. Communications links shown in FIG. 2 can each be any suitable communications link or combination of communications links, such as wired links, fiber optic links, Wi-Fi links, Bluetooth links, cellular links, etc.

In further examples, computing device 210 can further include a display 216 and/or one or more inputs 220. In some embodiments, the display 216 can include any suitable display devices, such as a computer monitor, a touchscreen, a television, an infotainment screen, etc. to display the report or any suitable result of detected malicious activity. In further embodiments, the input(s) 220 can include any suitable input devices and/or sensors that can be used to receive user input, such as a keyboard, a mouse, a touchscreen, a microphone, etc.

### Example Embodiments and Experiments

The following presents a discussion of the inventors' work toward developing certain example embodiments. The examples described below entail the development of a novel methodological framework that leverages AI techniques for (near-) real-time detection of network attacks. This AI-enabled framework overcomes the limitations of traditional packet-based NIDS by considering both header and payload data and analyzing temporal connections among packets. Another novel aspect of these examples is the unique representation of the network traffic data. The sequential packets in a communication flow are transformed into a two-dimensional image, enabling the application of convolutional neural networks (CNNs) for intrusion detection. This representation allows the development of an optimized CNN-based network intrusion detection model that captures the underlying patterns and features associated with the network attacks.

As a result of their experiments, the inventors found that malicious intent can be detected quite early in a network communication during an attack. The transmission of the fourth to the ninth packet in a two-way communication was sufficient to detect malicious activity with high accuracy in the inventors' experiments. This early detection capability is a paradigm shift in reducing response time to network attacks compared to existing pure-flow-based approaches that require analysis of a large number of packets before making a detection. The methodology has shown promising results of being deployable in diverse environments without requiring complete retraining, enhancing flexibility and efficiency for cybersecurity teams. One of the example embodiments comprises a sequential packets image-based network intrusion detection system (SPIN-IDS) framework, which also demonstrated robustness against adversarial examples, accurately detecting network attacks even with carefully crafted packet perturbations, unlike other ML/DL-based NIDS with high false negative rates.

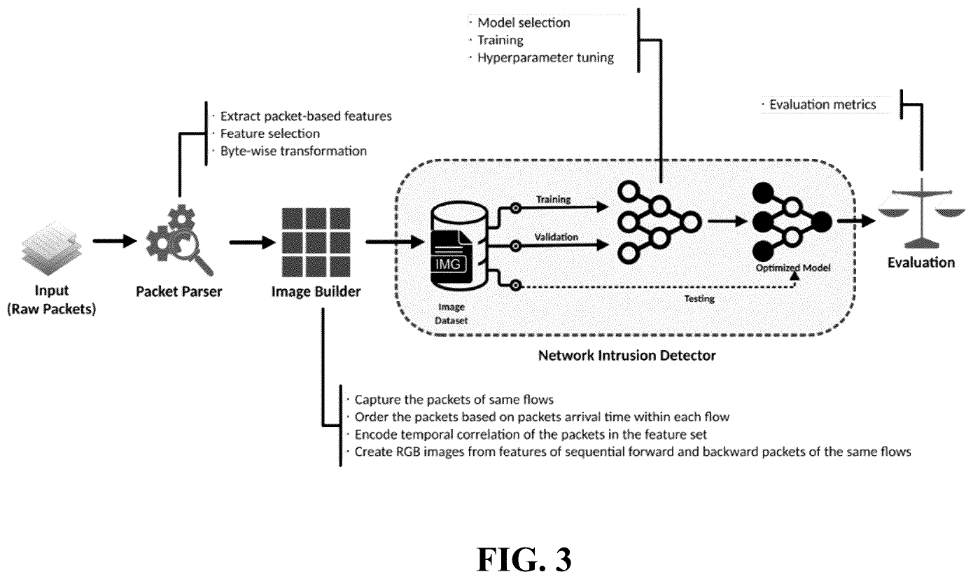

An example of an AI-enabled framework, shown in FIG. 3, solves the challenges described above in part by taking into account both header and payload data of the sequential packets in an evolving flow and transforming them into a two dimensional (2D) image representation. The SPIN-IDS framework can be thought of as including at least three components: (i) a packet parser, (ii) an image builder, and (iii) a network intrusion detector. The first component extracts packet-based features from the raw network traffic data. The second component preprocesses the extracted feature data to generate 2D images. Finally, the third component determines if the network traffic is malicious or not. Of course, each of these three components can be part of the same or separate software applications.

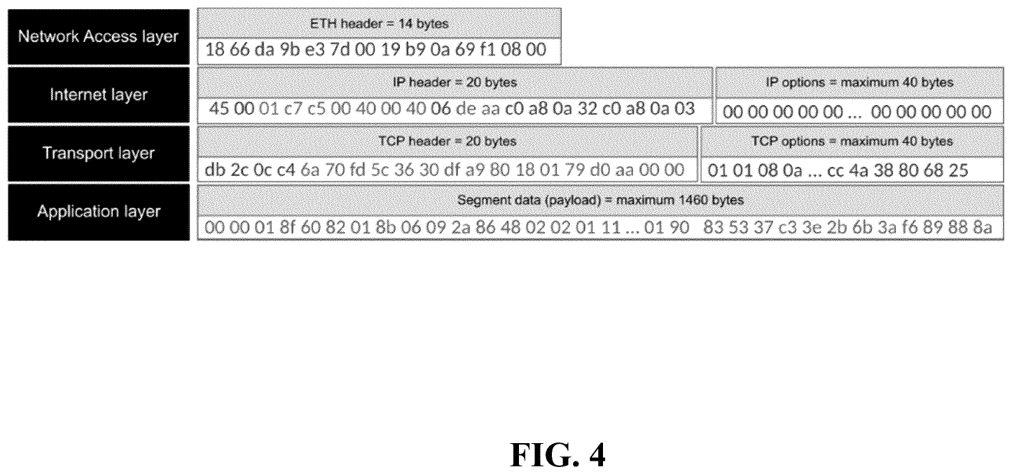

To understand packet-based feature extraction from a raw packet file, it is helpful to know the structure in which packets are stored. The TCP/IP model is a standard model used in network communication to regulate the procedure of information sharing across the internet. It includes four layers: the network access layer (also known as the host-to-network layer), the internet layer, the transport layer, and the application layer. The transmission control protocol is responsible for breaking the message into TCP segment packets and reassembling them at the destination. FIG. 4 displays the different TCP/IP layers, along with the number of information bytes at each layer. Network traffic data is often stored in the libpcap (pcap) format, which is considered to be a standard for network packet capture and widely used in packet sniffers and analysis tools like Wireshark.

The packet parser component takes the network traffic (in real-time or pcap files) as input data. Each packet transmitted through the TCP contains up to 1594 information bytes. Information related to the environment and protocols can bias the model and make it less applicable to different environments. Hence, to remove this bias, the Ethernet (ETH) header information (14 bytes), the IP version (one byte), the differentiated services field (one byte), the protocol (one byte), and the source and destination IP addresses information (four bytes each) from the IP header were eliminated in these examples. The source and destination ports information bytes (two bytes each) from the TCP header of each packet data were also removed. Additionally, the IP options and TCP options, which can cause misalignment between two packets of the same flow and introduce noise in the model, were removed. (Misalignment occurs when the bytes in two feature representations of packets with and without options are not aligned, leading to a decrease in model performance and interpretability.) Alternatively, a padding or other normalization scheme could be utilized.

To encode the temporal relationship between packets in the same flow, a delta time feature is introduced that calculates the time difference between two packets of the same flow using the epoch time of each packet.

After removing these information bytes (a total of 109 bytes, shown in red in FIG. 4) and encoding the temporal correlation feature into the feature space in one experiment, the resulting packet-based feature representation, V_{packet}, contained a maximum of 1486 bytes of information. Each byte represents a feature in the packet-based feature representation. Next, a byte-wise transformation is applied to the packet-based features, converting the hexadecimal byte values to the respective decimal values. The decimal value ranges from 0 (for 00 byte) to 255 (for ff byte), which is suitable for an image representation of the packet data. Since the number of bytes varies depending on the packet type, zero-padding is applied to the feature space to maintain a standard structure, resulting in a fixed number of features (N) for each packet.

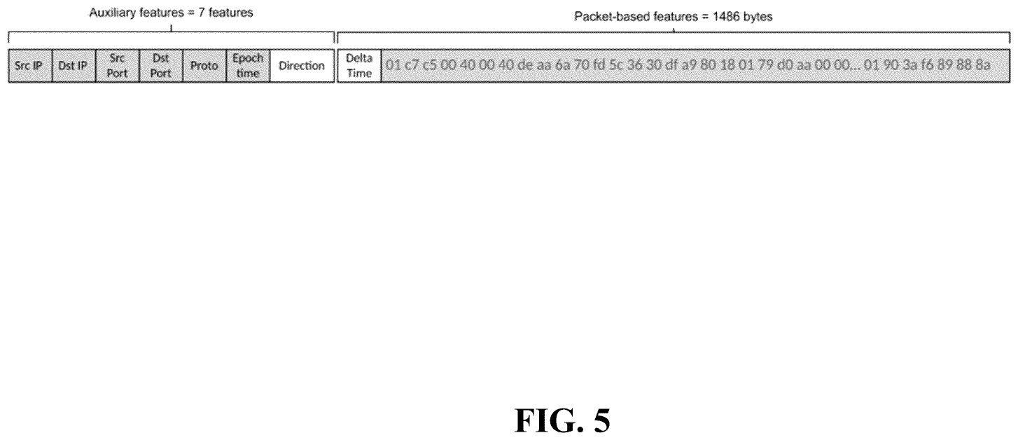

There are attacks aimed at keeping the destination (server) busy and consume its resources by sending multiple null packets with no particular malicious data (e.g., SYN flooding). It becomes important to differentiate between forward (attacker to server) and backward (server to attacker) packets. Hence, the direction of each packet is encoded as an auxiliary feature in the packet representation scheme. In total, seven auxiliary features are captured from each packet. These features include source IP address (SrcIP), destination IP address (DstIP), source port (SrcPort), destination port (DstPort), protocol (Proto), epoch time, and direction of the packet. In one embodiment, these seven features are only used in the image builder component as helpers to carry out the image creation process (as their name suggests) and are not part of the packet-based features. Therefore, the final size of the packet-based features is 1486 and only these features are used to create the images in the image builder component. FIG. 5 shows the packet-based data scheme. The output of the packet parser is a packet-based data which contains seven auxiliary features and a total of 1486 packet-based features. The direction and delta time features are initially set to null values for each packet. The direction and delta time features are computed in the image builder component. Algorithm 1 presents the packet parser process.

Algorithm 1: Algorithm for the packet parser process.

```
Input: Real-time network data/captured network data (pcap) files
Output: Transformed packet data
/* Set the packet-based features length to N for all packets. */
for each packet do
  Obtain the packet header and payload data
  Do feature selection from the header and payload data
  Do byte-wise transformation to convert hexadecimal bytes to decimal
    values (0-255)
  Assign transformed data to packet features vector V_{packet}
  Add the delta time feature to V_{packet} /* Set to Null */
  Do zero-padding if length(V_{packet}) ≠ N
  Capture and add the auxiliary features to V_{packet}
```

Image Builder: To capture the temporal-spatial relationships among the packets within a flow, the inventors developed a 2D (P×Q) image builder that uses sequential packets to generate snapshots of the evolving flow as new packets arrive. The transformed packet-based data obtained from the packet parser component serves as an input to the image builder component. With the help of the auxiliary features, the packets belonging to the same flow are extracted, and delta time and direction information is computed. Delta time is encoded as a feature, and the same-flow packets are stacked across the P dimension of the image to capture the temporal relationships. The spatial and semantic correlations in the packets are preserved by constructing a static representation of packet features across the Q dimension of the image. The P dimension can be determined by the security team of an organization and can be derived using statistical measures such as the mean or the median number of packets found in each flow in their respective network environment. The Q dimension is the length of the packet-based feature vector (1486), as defined in the packet parser component. It is to be noted that the construction of an image does not require all P number of packets from an ongoing flow.

The packet-based features are stored using an image with three channels, red (R), green (G), and blue (B). While not all embodiments use this image format, an RGB image format was chosen as an example implementation because the current state of the forward and backward packets allows for use of color to identify underlying back and forth traffic patterns in network attacks. Using a pure grayscale mode (whithout adding an additional flag or other signifier) would obscure this pattern in the data. Instead, the RGB channels provide information about how the forward and backward packets are played out in the flow. In most network communications, there are effectively only forward and backward packets, so only two color channels are used to encode directionality. The forward packet information is stored in the R channel of the images, and the backward packet information is stored in the G channel of the images. As a logical consequence, the incorporation of a B channel becomes superfluous in some embodiments, or can be leveraged to add additional channels of auxiliary information in other embodiments. When not used, the B channel is systematically zero-padded for all images to maintain the same structure across all images generated by the image builder component. Additionally, by storing information about forward packets in the R channel, which represents packets being transmitted by a sender, the impact of small perturbations in the packet data introduced by attackers to evade NIDS could be mitigated. Through the utilization of an image-based sequential packet representation, such perturbations or minor noise in the samples would be insufficient to alter the discernible patterns captured in these images. This process is conducted sequentially, and every time a packet arrives, the direction of the packet is checked, and the feature vector values are assigned to the respective channel, leaving the other two channels blank. In summary, the creation of images from network flows carries notable significance in several aspects. Firstly, it facilitates the capture of temporal-spatial relationships among packets within a flow by employing delta time as a feature and stacking same-flow packets across dimensions in the image. Secondly, the direction of packets within a flow is leveraged for identifying attacks, with the RGB channels of the image format storing information about forward and backward packet execution. Lastly, this approach significantly enhances model robustness by storing forward packet information in the R channel, potentially mitigating the impact of small perturbations introduced by attackers and ensuring the persistence of discernible patterns in the images.

For training the network intrusion detector (the third component in the framework), historical data sets available in the organizations can be used to create the training data. Alternatively, the training data can be created from the modern and preferred publicly available network intrusion data sets, such as those provided by the Canadian Institute of Cybersecurity (CIC) (CIC-IDS2017 and CIC-IDS2018).

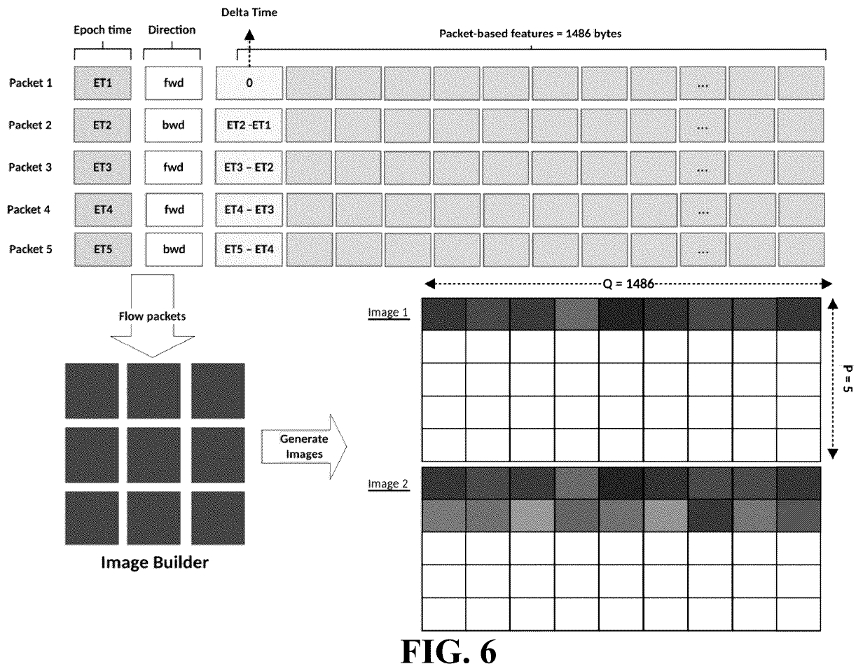

Each image created using the image builder component for the training phase is assigned the label of the network flow found in the historical/publicly available data. For instance, an image created from the packet data in CIC-IDS2017 data set will belong to one of the 15 different labels, including one benign and 14 attack types found in that data set. FIG. 6 illustrates the image builder process for an instance of an evolving flow with five packets. The first packet is transmitted in the forward direction. Consequently, the feature values of this packet are stored in the R channel of the image representation, while zero-padding the G and B channels for the first row. Conversely, the second packet is transmitted in the backward direction, and thus its feature values are assigned to the G channel of the image representation. In this case, the example zero-pads the R and B channels for the second row of the image. This process continues until all the five packets are represented in this image. Algorithm 2 presents the pseudo-code for the image builder process.

Algorithm 2: Algorithm for the image builder process

```
Input: Packet-based data (from Algorithm 1) and P.
Output: Image data
for each packet in packet-based data do
  Obtain the flow packets as follows:
  Identify packets with same tuple (SrcIP, DestIP, SrcPort, Proto) and
  label
    them forward packets
  Identify packets with same tuple (DestIP, SrcIP, DestPort, SrcPort,
  Proto)
    and label them backward packets
  Store the flow packets based on epoch time
  for each packet in flow do
    (delta time)_{packet} = (epoch time)_{packet} − (epoch time) _{previous packet}
    Transform (delta time)_{packet} between [0, 255]
    Encode (delta time) in packet-based feature vector (V_{packet})
  end
  Set the image dimension to (P × 1486 × 3)
  zero-pad red (R), green (G), and blue (B) channels
  p ← 0 /* enumerates row of images for sequential process */
  for each packet in flow do
    if p ≥ P then
      break
    else if packet direction is forward then
      Assign feature vector of packet to row p of R channel
    else
      /* the packet direction is backward */
      Assign the feature vector of packet to row p of G channel
    end
    Create the image of p packets in the flow
    p + +
  end
  Remove flow packets from packet-based data
end
return Image data
```

Algorithm 3: Algorithm for training and validating the network
intrusion detector

```
Input: Training image data, validation image data, hyper-parameter set,
and CNN model architecture
Output: Optimized model
while Training ≠ done do
  for every hyperparameter selection do
    For each epoch in epoch range
      Create image batches from training and validation image
        data
      Train the CNN model with training image batches
      Evaluate the model performance with validation image
        data
      if EarlyStopping is True break else continue
      Record hyperparameter selection and model performance
        on validation image data
    end
  end
end
  hoose the best hyperparameter selection for the model
return Optimized model
```

Network Instrusion Detector: One objective of a network intrusion detector according to the present disclosure is to determine whether an image, obtained from the image builder component, contains benign or malicious traffic. To achieve this objective, the problem of intrusion detection can be structured as a binary image classification problem. (As noted above, however, both lower and higher-order classification implementations are also contemplated). The classification is centered on identifying the ongoing network activity's nature, categorizing it as either benign or malicious. In one experiment, the inventors evaluated the use of a CNN architecture for the development of the detector. CNN models are well known for having a distinct multilayer neural network architecture compared to the feedforward models. In particular, CNNs can include an input layer, an output layer, and multiple hidden layers, typically comprising of convolutional, pooling (such as maxpooling), and fully connected layers. The operations in the CNN model include convolution and sampling processes. During the convolution process, various filters are applied to the original data or feature map and a bias is added. The convolution process for an input image sample is based on the following equation, in which L represents the input image's length, K is the kernel size, Z denotes the amount of zero-padding added to both ends of the image dimension, and S is the stride of the kernel on a convolution layer

$${L}^{′} = \frac{( L - K + 2 Z )}{S} + 1 \qquad ( 1 )$$

Although using multiple convolution layers can potentially lead to better learning of images with complex features, the number and performance of these layers are not always proportional. Hence, an ideal architecture must be selected during the training phase from a wide range of possibilities, such as from shallow (with only one convolutional layer) to deep (with multiple convolutional layers) architectures along with different padding and stride strategies. An appropriate loss function and activation function must also be selected that suits the problem type (binary classification), along with the optimal tuning of other hyperparameters. During the training phase, different images are created from each flow, with an incremental number of sequential packets observed in that communication. An example of a training and validation process of a network intrusion detector model is outlined in Algorithm 3.

Evaluation: The performance of an example detector is evaluated using a range of metrics, commonly employed for intrusion detection models. These metrics are calculated using the following model prediction values on the testing data samples:

Below are the various metrics used in the experiments to evaluate the model performance:
Accuracy: It is the ratio of the total number of correctly classified samples of both classes and the total number of samples, as given below:

$$Accuracy = \frac{TP + TN}{TP + TN + FP + FN} \qquad ( 2 )$$

Precision: It is the ratio of the number of correctly classified attacks and the total number of samples predicted as attacks by the model, as given below:

$$Precision = \frac{TP}{TP + PF} \qquad ( 3 )$$

True positive rate (TPR) or Recall: It is also known as the detection rate (DR) and is the ratio of correctly classified attack samples and the total number of attack samples, as given below:

$$TPR ( Recall ) = \frac{TP}{TP + FN} \qquad ( 4 )$$

F1 score: It is the harmonic mean of precision and recall values for examining the accuracy of the model, as given below:

$$F 1 = 2 \times \frac{Precision \times Recall}{Precision + Recall} \qquad ( 5 )$$

True negative rate (TNR): It is the ratio of the number of correctly classified benign samples and the total number of benign samples, as given below:

$$TNR = \frac{TN}{TN + FP} \qquad ( 6 )$$

False negative rate (FNR): It is the ratio of the number of incorrectly classified attack samples and the total number of attack samples, as given below:

$$FNR = \frac{FN}{TP + FN} \qquad ( 7 )$$

False positive rate (FPR): It is also known as the false alarm rate (FAR) and is the ratio of incorrectly classified benign samples and the total number of benign samples.

$$FPR ( FAR ) = \frac{FP}{FP + TN} \qquad ( 8 )$$

Numerical Experiments: This section presents an overview of the numerical experiments conducted to assess the methodology. First, the section provides details of the network traffic data used in the inventors' experiments, followed by the process of creating image representation of the data. This section then describes how the inventors split the data into training, validation, and testing data sets to develop an embodiment of a network intrusion detector. The experiments were conducted using a 12th Generation Intel Core i9-12950HX processor (30 MB cache, 24 threads, 16 cores). In order to speed up the training process, NVIDIA RTX A5500 graphics card (16 GB GDDR6 SDRAM) was utilized with the latest installation of CUDA, a universal parallel computing framework, and cuDNN, a deep neural network acceleration library.

TABLE 1
CIC-IDS2017 pcap file details

| Day/Date | File Size | Activity |
|---|---|---|
| Monday/Jul. 3, 2017 | 11 GB | Benign |
| Tuesday/Jul. 4, 2017 | 11 GB | Brute Force and Benign |
| Wednesday/Jul. 5, 2017 | 13 GB | DoS and Benign |
| Thursday/Jul. 6, 2017 | 7.7 GB | Web Attack, Infiltration, |
| | | and Benign |
| Friday/Jul. 7, 2017 | 8.2 GB | Botnet, Port Scan, DDoS, |
| | | and Benign |

TABLE 2
Packet details per attack type in CIC-IDS2017

| | Number of Packets | |
|---|---|---|
| Attack Type | Forward | Backward |
| DoS GoldenEye | 66795 | 39382 |
| DoS Hulk | 1246802 | 1000016 |
| DoS Slowhttptest | 32635 | 7027 |
| DoS Slowloris | 37236 | 10350 |
| DDoS | 754735 | 510922 |
| Heartbleed | 28412 | 20884 |
| SSH Patator | 65695 | 97616 |
| FTP Patator | 43507 | 67229 |
| Botnet | 4788 | 5083 |
| Infiltration | 29881 | 29873 |
| Port Scan | 162630 | 160677 |
| Web Attack-Brute force | 19755 | 10304 |
| Web Attack-XSS | 6361 | 3277 |
| Web Attack-SQL Injection | 67 | 59 |

Data Description: The inventors conducted numerical experiments using the raw pcap files from two well-known network intrusion detection data sets, namely CIC-IDS2017 and CIC-IDS2018. These data sets comprise both benign and attack communications and offer a more practical representation of contemporary network traffic in comparison to older network intrusion data sets such as NSL-KDD and KDD-CUP. The pcap files for CIC-IDS2017 contain network traffic data for five consecutive days (Monday to Friday), each featuring distinct attack types and sizes, as shown in Table 1. In one experiment, an example used Python-based dpkt and Scapy to parse the raw network traffic and create the packet-based feature data set, as described below. Table 2 presents the number of forward and backward packets that were extracted for each attack type. The inventors validated the output of the packet parser component for each attack type using the corrected version of the public NetFlow CSV files for the CIC-IDS2017 data.

To assess the transferability of the trained network intrusion detector model on distinct network traffic data (domain adaptability characteristic), the inventors utilized CIC-IDS2018 data. The CIC-IDS2018 data features various attack types and sizes of pcap files, as shown in Table 3. To demonstrate the adaptability of embodiments of an AI-enabled SPIN-IDS framework with the trained network intrusion detector, the inventors extracted packets for the following attack types, DoS, Web Attack, Infiltration, and Brute Force, from these large pcap files. The number of forward and backward packets extracted for these attacks is presented in Table 4.

TABLE 3
CIC-IDS2018 pcap file details

| Day/Date | File Size | Activity |
|---|---|---|
| Wednesday/Feb. 14, 2018 | 40 GB | SSH and FTP Patator, and |
| | | Benign |
| Thursday/Feb. 15, 2018 | 41.3 GB | DoS GoldenEye, DoS |
| | | Slowloris, and Benign |
| Friday/Feb. 16, 2018 | 38.6 GB | DoS Slowhttptest, DoS |
| | | Hulk, and Benign |
| Thursday/Feb. 22, 2018 | 50.3 GB | Web Attack and Benign |
| Friday/Feb. 23, 2018 | 60 GB | Web Attack and Benign |
| Wednesday/Feb. 28, 2018 | 53.3 GB | Infiltration and Benign |

TABLE 4
Packet details per attack type in CIC-IDS2018

| | Number of Packets | |
|---|---|---|
| Attack Type | Forward | Backward |
| DoS GoldenEye | 154774 | 98976 |
| DoS Hulk | 1028619 | 107067 |
| Infiltration | 236560 | 86054 |
| FTP Patator | 193360 | 193360 |
| Web Attack-Brute force | 20735 | 14158 |
| Web Attack-XSS | 22289 | 11586 |

Image Data Creation: After extracting packet-based feature data from both CIC-IDS2017 and CIC-IDS2018 pcap files, the image builder component was utilized to create image data sets following the procedure outlined herein. The inventors used the CIC-IDS2017 data for the development of the network intrusion detector in this framework. The CIC-IDS2018 data, representing a different network environment, was used to generate images to evaluate the transferability of the trained detector. A goal for some embedments may be to detect maliciousness in a network communication as early as possible. The parameter P determines the height of the image, indicating the maximum number of sequential packets from a flow that can be used in the image sample. This value should be set sufficiently large to capture the intricate patterns associated with various malicious attacks. Simultaneously, the value of P should be small enough to enable the generation of a compact dimensional image, ensuring efficiency in processing. Hence, to determine the appropriate value of P, the inventors examined the flow-related statistics associated with each attack type in CIC-IDS2017 data set (see Table 5).

In Table 5, the column labeled ‘Number of Flows’ presents the total count of flows extracted from both the benign and attack classes. Since the number of packets may vary within each flow, various statistical measures, such as the average, median, and mode, have been computed to comprehensively capture these variations. For instance, the average number of packets, indicated in the ‘Average Packets’ column for benign flows, is 85.76. In contrast, the mode value in the ‘Mode Packets’ column associated with benign flows is 14, suggesting that flows with 14 packets are the most frequently occurring case. It is important to note that the counts include both forward and backward packets in the benign and attack flows.

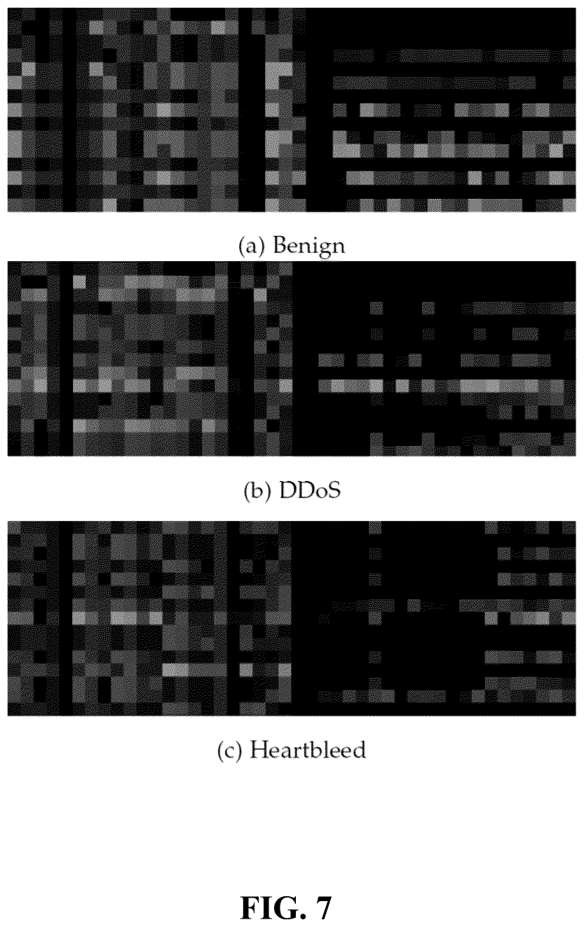

Upon examination of Table 5, it becomes evident that the average is elevated for all benign and attack classes, while the median and mode exhibit relatively lower values. This observation suggests a right-skewed distribution, where a minority of extremely high values exerts an upward influence on the average. In such cases, selecting the median value as the maximum height for the image proves beneficial. This approach ensures that an ample number of packets are included to capture the network communication's intent, while simultaneously maintaining a significantly lower image dimension compared to using the average value for the maximum image height. Therefore, for one embodiment the inventors selected the median number of packets per attack type to determine the value of P for image construction. The inventors used the rounded average median value of 15 for P and set the dimension of the images to be generated in the image builder component to (15×1486×3). For each flow, the inventors created various images ranging from one packet to P number of sequential packets, resulting in up to P number of images per flow. The resulting image data set from the image builder component is presented in Table 6, where ‘pkt’ is used as a shorthand for ‘packet’. Each column in this table denotes an image representation with a fixed number of packets extracted from the flows belonging to various network activities (one benign and 14 attack types). For instance, the last column (15 pkts) represents the image data containing 61159 images belonging to the benign class (label 0) and 15636 images belonging to the DDOS class (label 14), along with images from other classes as shown in that column. All these images (in the last column) contain the first 15 sequential packets found in the communication of the respective flows. FIG. 7 shows some samples of the image data (with truncated width).

Next, the inventors created three separate data sets, one each for training, validating, and testing the network intrusion detector. The inventors took the following into account while splitting the image data:
To ensure that the CNN-based network intrusion detection model is trained effectively, the experiments excluded the Web Attack-XSS, Web Attack-SQL Injection, and Botnet attack classes since there were small numbers of images for these classes across the different data sets, as shown in the highlighted rows of Table 6.
To ensure that the model is not biased towards any particular representation, the experiments sampled the same number of images during training from each representation (1 pkt to 14 pkts) as found in the last data set (15 pkts).
To ensure that the model is not validated or tested using different image representations of the same flows that were used during its training, the experiments created three data sets (training, validation, and testing), each containing all P image representations of distinct flows.
To ensure that the model is trained with a balanced data set, the experiments sampled (near-) equal number of images from each attack type in a way that the total number of images belonging to the malicious class (i.e., all attack types combined) matches that of the benign class. In particular, the inventors' experiments sampled 100 same flow images from each attack type, except for the FTP-Patator class, for which the inventors' experiments sampled 89 images from each of the 15 representations.

TABLE 5
Flow Statistics per Attack Type in CIC-IDS2017

| Attack | Activity | Number of | Average | Median | Mode |
|---|---|---|---|---|---|
| Type | Level | Flows | Packets | Packets | Packets |
| Benign | 0 | 103138 | 85.76 | 15 | 14 |
| DoS | 1 | 1554 | 30.62 | 10 | 7 |
| Slowloris | | | | | |
| DoS | 2 | 1586 | 25.07 | 13 | 2 |
| Slowhttptest | | | | | |
| DoS Hulk | 3 | 128566 | 17.47 | 14 | 14 |
| DoS | 4 | 6704 | 15.83 | 14 | 14 |
| GoldenEye | | | | | |
| Heartbleed | 5 | 1656 | 29.76 | 21 | 6 |
| FTP-Patator | 6 | 475 | 233.13 | 6 | 4 |
| SSH-Patator | 7 | 457 | 357.35 | 6 | 4 |
| Web | 8 | 222 | 135.45 | 17 | 2 |
| Attack- | | | | | |
| Brute Force | | | | | |
| Web | 9 | 69 | 139.68 | 3 | 2 |
| Attack-XSS | | | | | |
| Web | 10 | 2 | 63 | 63 | 63 |
| Attack-SQL | | | | | |
| Injection | | | | | |
| Infiltration | 11 | 4254 | 14.04 | 6 | 2 |
| Botnet | 12 | 736 | 13.41 | 9 | 9 |
| PortScan | 13 | 7674 | 42.13 | 22 | 6 |
| DDoS | 14 | 167232 | 7.56 | 2 | 2 |
| Average | | 28288.33 | 80.68 | 14.73 | 10.06 |

TABLE 6
Data sets of generated images with different number of packets (pkts)

| Activity | Number of samples per image representation | | | | | |
|---|---|---|---|---|---|---|
| Label | 1 pkt | 2 pkts | 3 pkts | 4 pkts | 5 pkts | 6 pkts |
| 0 | 103138 | 102889 | 102688 | 101637 | 101547 | 101320 |
| 1 | 1554 | 1529 | 1522 | 1342 | 1331 | 1269 |
| 2 | 1586 | 1581 | 1296 | 1109 | 1093 | 1074 |
| 3 | 128566 | 128339 | 128207 | 127508 | 127457 | 127297 |
| 4 | 6704 | 6607 | 6580 | 6539 | 6484 | 6312 |
| 5 | 1656 | 1656 | 1652 | 1650 | 1642 | 1632 |
| 6 | 475 | 464 | 461 | 437 | 275 | 260 |
| 7 | 457 | 457 | 454 | 420 | 265 | 254 |
| 8 | 222 | 221 | 166 | 160 | 147 | 144 |
| 9 | 69 | 66 | 41 | 27 | 21 | 19 |
| 10 | 2 | 2 | 2 | 2 | 2 | 2 |
| 11 | 4254 | 3798 | 3334 | 2921 | 2550 | 2253 |
| 12 | 736 | 736 | 736 | 736 | 736 | 736 |
| 13 | 7674 | 7671 | 7506 | 7386 | 7306 | 7284 |
| 14 | 167232 | 167118 | 33812 | 33507 | 33073 | 32996 |
| Activity | Number of samples per image representation | | | | | |
| Label | . . . | 11 pkts | 12 pkts | 13 pkts | 14 pkts | 15 pkts |
| 0 | . . . | 92548 | 89580 | 83490 | 74974 | 61159 |
| 1 | . . . | 769 | 721 | 651 | 606 | 585 |
| 2 | . . . | 883 | 830 | 796 | 774 | 737 |
| 3 | . . . | 120492 | 116460 | 102844 | 83426 | 53841 |
| 4 | . . . | 5852 | 5645 | 4864 | 3849 | 2301 |
| 5 | . . . | 1334 | 1304 | 1271 | 1245 | 1211 |
| 6 | . . . | 121 | 106 | 96 | 93 | 89 |
| 7 | . . . | 142 | 135 | 126 | 120 | 115 |
| 8 | . . . | 135 | 133 | 131 | 130 | 127 |
| 9 | . . . | 17 | 16 | 16 | 15 | 15 |
| 10 | . . . | 2 | 2 | 2 | 2 | 2 |
| 11 | . . . | 1203 | 1057 | 933 | 834 | 743 |
| 12 | . . . | 116 | 45 | 45 | 44 | 44 |
| 13 | . . . | 5953 | 5813 | 5730 | 5633 | 5466 |
| 14 | . . . | 30490 | 28721 | 25573 | 20575 | 15636 |

Finally, after taking the aforementioned factors into consideration, the samples were divided into three data sets, training (70%), validation (15%), and testing (15%).

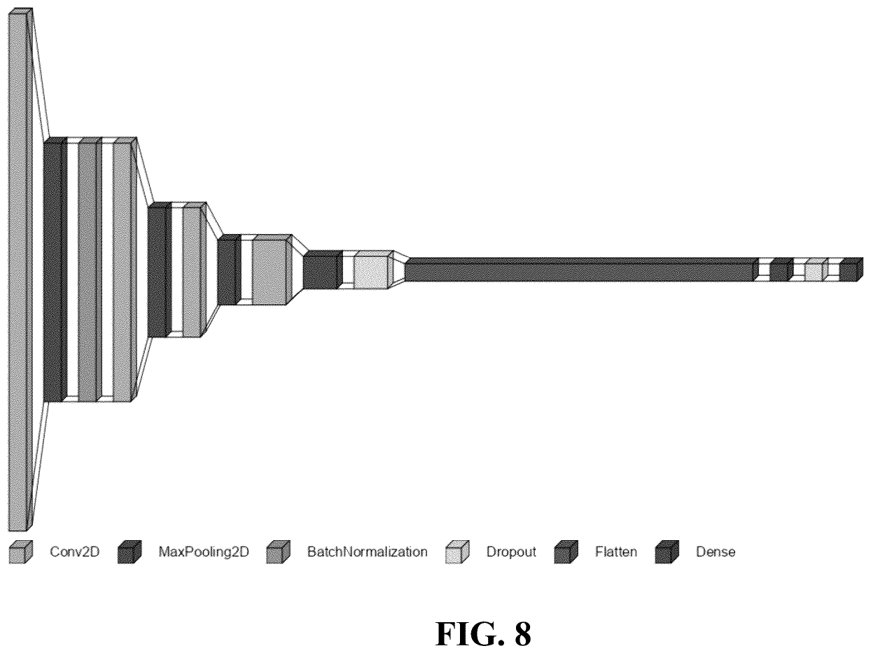

Network Instrusion Detection Model Development: The inventors tested various CNN architectures such as shallow (with only one convolutional layer) to deep (with seven convolutional layers) architectures along with different padding and stride strategies. Also, different pooling layer strategies, including maximum and average pooling were experimented to find the optimal architecture of the CNN model for network intrusion detector. The resulting optimal structure is depicted in FIG. 8. The convolutional layers in the model use same padding strategy so that the output image size is the same as the input size for each convolutional layer, and the stride was set to the default value of S=(1,1). To speed up the learning process and improve stability, a batch normalization layer was used after the first pooling layer. To prevent overfitting, two dropout layers with a drop rate of 20% were included during training.

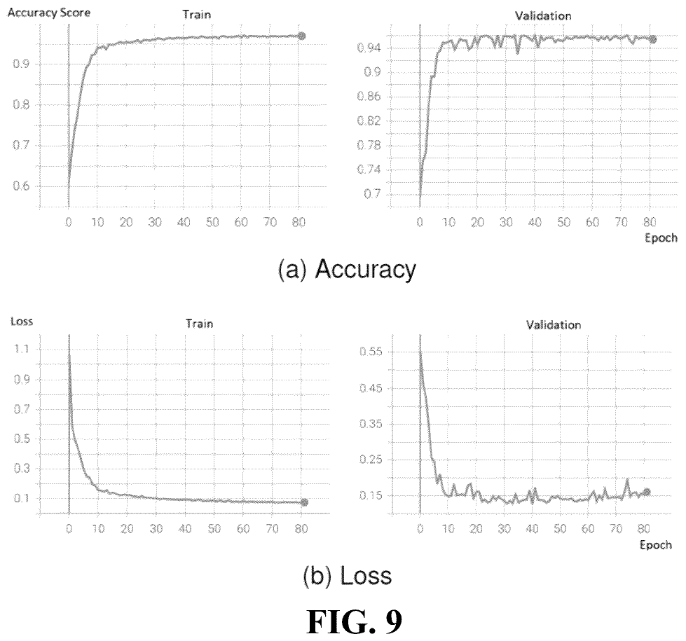

Since the CNN model in this example is used for binary classification (benign or malicious), the inventors used Binary Crossentropy as the loss function and the Sigmoid activation function in the last dense layer to produce output values in the range of [0,1]. The inventors optimized the important hyperparameters of this embodiment of the CNN architecture using the training and validation data sets. To achieve this, the inventors implemented the CNN model in Tensorflow and utilized KerasTuner and TensorBoard for hyperparameter optimization. Table 7 shows the hyperparameter values used in the experiments and the best values selected for the model. The number of epochs for training was set to 100 for all trials. The learning curves for the best parameter values are shown in FIG. 9. The inventors then used this optimized model on the testing data set to evaluate the performance of the approach using different test case scenarios.

Results and Analysis: This section presents the results and analysis of the experiments conducted using the example AI-enabled SPIN-IDS framework. This section first demonstrates the efficacy of the approach using the test data set (CIC-IDS2017). This section then analyzes the performance across the different image representations and extracts insights into the potential timing of malicious information transmission. This section then assesses the detection capabilities across the different types of network attacks and perform statistical analysis to detect deviations from benign behavior during network attack communications. This section also validates the resilience of the approach against adversarially crafted examples and examines the adaptability of the trained network intrusion detector in a new target network environment (CIC-IDS2018). Finally, This section compares the approach with other packet-based methods from recent literature.

TABLE 7
Hyperparameter values for the CNN-based netowrk intrusion
detector model

| Hyperparameter | Hyperparameter Values | Best value |
|---|---|---|
| Activation | [ReLU, tanh, LeakyReLU] | [ReLU, tanh, LeakyReLU] |
| function | | |
| Kernel initializer | [GlorotNormal[?], | [GlorotNormal[?], |
| | HeNormal[?], | HeNormal[?], |
| | RandomUniform] | RandomUniform] |
| Convolutional | (min_value = 16, | (min_value = 16, |
| layer 1 filter | max_value = 128, | max_value = 128, |
| | step = 16) | step = 16) |
| Convolutional | [(3, 3), (4, 4), (5, 5)] | [(3, 3), (4, 4), (5, 5)] |
| layer 1 kernel | | |
| Convolutional | (min_value = 32, | (min_value = 32, |
| layer 2 filter | max_value = 256, | max_value = 256, |
| | step = 32) | step = 32) |
| Convolutional | [(3, 3), (4, 4), (5, 5)] | [(3, 3), (4, 4), (5, 5)] |
| layer 2 kernel | | |
| Convolutional | (min_value = 32, | (min_value = 32, |
| layer 3 filter | max_value = 512, | max_value = 512, |
| | step = 32) | step = 32) |
| Convolutional | [(3, 3), (4, 4), (5, 5)] | [(3, 3), (4, 4), (5, 5)] |
| layer 3 kernel | | |
| Convolutional | (min_value = 32, | (min_value = 32, |
| layer 4 filter | max_value = 512, | max_value = 512, |
| | step = 32) | step = 32) |
| Convolutional | [(3, 3), (4, 4), (5, 5)] | [(3, 3), (4, 4), (5, 5)] |
| layer 4 kernel | | |
| Dense layer 1 | (min_value = 16, | (min_value = 16, |
| units | max_value = 128, | max_value = 128, |
| | step = 16) | step = 16) |
| Batch size | [64, 128, 256, 512] | [64, 128, 256, 512] |
| Learning rate | [1e−2, 1e−3, 1e−4] | [1e−2, 1e−3, 1e−4] |
| Optimizer | [SGD, RMSprop, Adam] | [SGD, RMSprop, Adam] |

Performance Across Different Image Representations: As described in herein, the test data samples comprise of images from 15 different image representations for the same flows, i.e., from one packet to 15 sequential packets obtained from the same network flow in the respective images. The inventors' experiments used each of the 15 representations as a subset of the test data. Subset 1 consisted of images generated from the first packet of the flows, subset 2 contained images created from the first and second packets of the same flows, and subsequent subsets with images in the same sequential pattern for the first 15 packets. In each of these 15 subsets, The inventors' experiments kept near-equal number of samples from each attack type, all of which constituted the malicious class. Also, the inventors selected near-equal number of samples from the benign class to keep the balance with malicious class samples. Each subset contained 328 images, with 165 belonging to the benign class and 163 to the malicious class.

TABLE 8
Model performance on different image representations of CIC-IDS2017 test data

| | | | | | | TRP | FPR |
|---|---|---|---|---|---|---|---|
| Subset | Accuracy | Precision | F1 | TNR | FNR | (Recall) | (FAR) |
| 1 | 0.7439 | 0.9247 | 0.6719 | 0.9576 | 0.9576 | 0.5276 | 0.0424 |
| 2 | 0.8933 | 0.9638 | 0.8837 | 0.9697 | 0.9697 | 0.8160 | 0.0303 |
| 3 | 0.9177 | 0.9658 | 0.9126 | 0.9697 | 0.9697 | 0.8650 | 0.0303 |
| 4 | 0.9543 | 0.9868 | 0.9524 | 0.9879 | 0.9879 | 0.9202 | 0.0121 |
| 5 | 0.9665 | 0.9872 | 0.9655 | 0.9879 | 0.9879 | 0.9448 | 0.0121 |
| 6 | 0.9787 | 0.9815 | 0.9785 | 0.9818 | 0.9818 | 0.9755 | 0.0182 |
| 7 | 0.9787 | 0.9815 | 0.9785 | 0.9818 | 0.9818 | 0.9755 | 0.0182 |
| 8 | 0.9817 | 0.9758 | 0.9817 | 0.9758 | 0.9758 | 0.9877 | 0.0242 |
| 9 | 0.9878 | 0.9877 | 0.9877 | 0.9879 | 0.9879 | 0.9877 | 0.0121 |
| 10 | 0.9817 | 0.9816 | 0.9816 | 0.9818 | 0.9818 | 0.9816 | 0.0182 |
| 11 | 0.9817 | 0.9816 | 0.9816 | 0.9818 | 0.9818 | 0.9816 | 0.0182 |
| 12 | 0.9817 | 0.9816 | 0.9816 | 0.9818 | 0.9818 | 0.9816 | 0.0182 |
| 13 | 0.9817 | 0.9816 | 0.9816 | 0.9818 | 0.9818 | 0.9816 | 0.0182 |
| 14 | 0.9817 | 0.9816 | 0.9816 | 0.9818 | 0.9818 | 0.9816 | 0.0182 |
| 15 | 0.9817 | 0.9816 | 0.9816 | 0.9818 | 0.9818 | 0.9816 | 0.0182 |

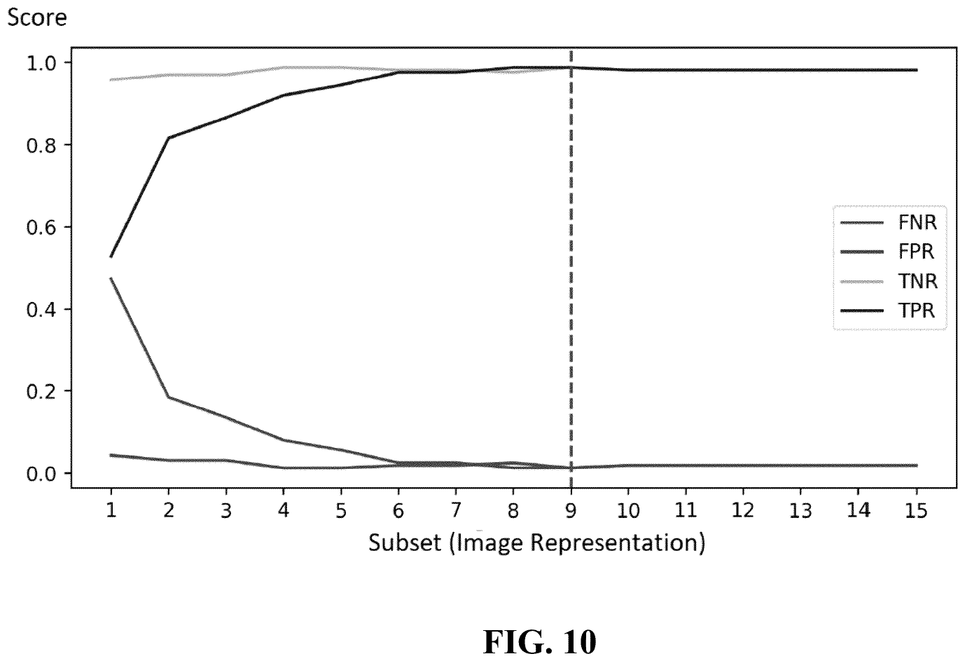

Table 5 shows the model's performance on these subsets of images using different metrics. It can be observed that the performance improves as the number of packets in flows increases, as evidenced by all the metric values. The best performance across all the metrics is observed with nine sequential packets in the image data with a TPR of 98.77%. FIG. 10 provides a visual of the performance improvement with the increase in the number of packets in the images. The performance is shown to plateau after nine packets in the image representation, indicating that the maliciousness in network traffic can be identified with high accuracy within the first nine sequential packets of the evolving flow. It can also be observed that the model cannot accurately identify malicious patterns in images when only the first packet of malicious traffic is transmitted, as indicated by the TPR of 52.76%. This result indicates that the first packet of the communication may not have malicious intent and that the malicious packets are transmitted later in the communication. Remarkably, the model achieves a TPR of 92.02% after the transmission of only four packets. This result indicates that typically there is no maliciousness in the first three packets, as they are a part of the TCP three-way handshake used to establish a reliable connection. Experiment results show that the methodology is able to accurately detect malicious activity early in the communication, within the first nine packets compared to flow-based approaches that have to wait for, on an average, 80 packets to be transmitted (see Table 4.2). Next, this section presents the performance of the model in detecting images belonging to the various types of network attacks.

Performance in Detecting Different Network Attacks: For this experiment, the invenotrs considered all the remaining images with nine sequential packets from all attack types that were not used during testing and validation of the network intrusion detection model. Table 7 shows the performance metric values obtained using the trained model with the nine sequential packets image data for each attack type. The average TPR or recall score across all attack types exceeds 98.5%, indicating that the model successfully identified the underlying malicious patterns for the attacks. The model was able to attain 100% accuracy in detecting both SSH-Patator and FTP-Patator attack images, among other results. The findings indicate that the SPIN-IDS framework with the CNN-based network intrusion detector and image representation with nine sequential packets performs very well in detecting all types of network attacks and keeping the false negative and positive values significantly low.

TABLE 9
Detection analysis per attack type

| Attack | Size | Accuracy | Precision | F1 | TNR | FNR | TPR | FPR |
|---|---|---|---|---|---|---|---|---|
| DOS | 1728 | 0.9838 | 0.9860 | 0.9838 | 0.9861 | 0.0185 | 0.9815 | 0.0139 |
| Slowloris | | | | | | | | |
| DoS | 1680 | 0.9875 | 0.9858 | 0.9875 | 0.9857 | 0.0107 | 0.9893 | 0.0143 |
| Slowhttptest | | | | | | | | |
| DoS Hulk | 164735 | 0.9787 | 0.9936 | 0.9855 | 0.9819 | 0.0223 | 0.9777 | 0.0181 |
| DoS | 11864 | 0.9729 | 0.9612 | 0.9733 | 0.9602 | 0.0143 | 0.9857 | 0.0398 |
| GoldenEye | | | | | | | | |
| Heartbleed | 2670 | 0.9843 | 0.9850 | 0.9843 | 0.9850 | 0.0165 | 0.9835 | 0.0150 |
| FTP-Patator | 150 | 1 | 1 | 1 | 1 | 0 | 1 | 0 |
| SSH-Patator | 134 | 1 | 1 | 1 | 1 | 0 | 1 | 0 |

Next, this section describes a statistical analysis performed by the inventors to determine when the deviation in benign behavior occurs in the malicious flows. The inventors used a statistical measure for image comparison to assess how malicious traffic varies compared to a normal (benign) traffic flow. For this, a representative image is created for each attack type by averaging the pixel values of all sample images that belong to a specific image representation (one packet, two packets, . . . , 15 packets) of the flow. Likewise, a representative image is generated for the corresponding image representation of normal traffic. The two representative images are then compared using the peak signal-to-noise ratio (PSNR) similarity metric. The PSNR score is determined using the following equation:

$$PSNR = 10 {log}_{10} \frac{{( {2}^{d} - 1 )}^{2} PQ}{{\sum }_{i = 1}^{P} {\sum }_{j = 1}^{Q} {( p [ i , j ] - p ′ [ i , j ] )}^{2}} \qquad ( 9 )$$

where d refers to the number of channels in the images, Q and P represent the width and height of the images, respectively, and p [i, j] and p′[i, j] denote the pixel values in the i-th row and j-th column of the normal and malicious representative images, respectively. PSNR metric does not adhere to a fixed range of values. Measured in decibels (dB), PSNR typically spans a range, where higher values indicate high similarity between the benign and attack image. In this example, the interpretation of the PSNR range is outlined as follows:
High PSNR (e.g., above 30 dB): Implies that the attack image closely matches the benign image.
Moderate PSNR (around 20-30 dB): Indicates moderate resemblance with little differences between the attack and benign images.
Low PSNR (below 20 dB): Signifies a significant disparity between the attack and benign images.

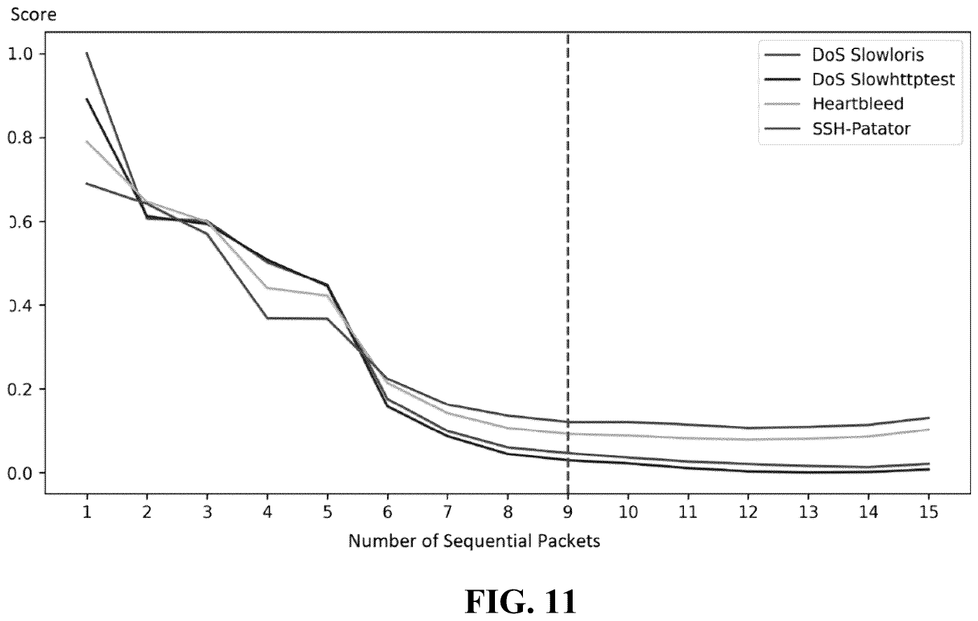

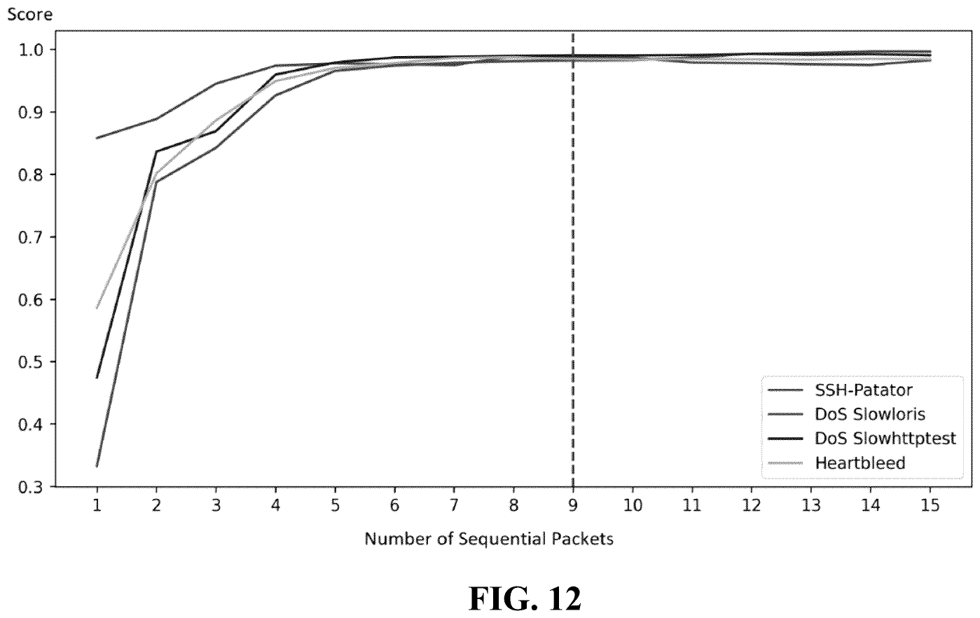

The inventors' experiments conducted the analysis using all 15 subsets (image representations) for each attack type. This section presents the findings for the four attack types, namely, SSH-Patator, DoS Slowloris, DoS Slowhttptest, and Infiltration. FIG. 11 shows the PSNR scores obtained for these attack types relative to the benign image. The PSNR values presented in the graph are normalized values of the actual PSNR values, offering a percentage-based interpretation. The actual PSNR values ranged from 23.76 dB to 53.70 dB. Notably, the PSNR values for images containing one to six packets for all attacks exceed 30 dB, suggesting very few subtle differences between the benign and attack images, which are imperceptible to human-based detectors. Beyond the 6-packet representation, the PSNR values remain above 20 dB, indicating the presence of some differences between the benign and attack images. FIG. 12 shows the recall scores or the detection rate for the four attack types using each of the subsets for a correlation analysis. The inventors also observed similar patterns for the other attack types.

The recall and PSNR score graphs presented for each attack type reveal a strong correlation between specific packets and the model's performance, consistent with the PSNR scores. For example, the recall score for the DoS Slowloris attack type for the subset containing only one packet is the lowest (33.3%) compared to other attack types. From the PSNR score, it is apparent that there are significant similarities between the representative image of the DoS Slowloris attack type with one packet and that of the benign class. However, when the second packet is added to the DoS Slowloris flow, the recall score improves sharply to 78.7%, which is the steepest increase, and the PSNR score decreases significantly to 60.6%, which is the steepest decline in the PSNR graph. Similar observations can be made for other attack types. Though the first three packets are a part of the TCP three-way handshake, there are certain bytes in packet headers relaying information that help in identifying ongoing traffic's maliciousness such as time-to-live (TTL) value, IP flags, urgent pointer, and window size bytes. The approach captures both the header and payload data, and hence, the network intrusion detector is able to detect deviations from a benign network communication in such samples. Importantly, it is observed that the PSNR and recall scores plateau after nine sequential packets have been transmitted for each attack type, strongly indicating that packets with malicious intent were a part of this initial transmission in the evolving flow. Next, this section evaluates the robustness of the approach against adversarial examples crafted for deceiving the NIDS.

Performance Against Adversarial Examples: Simulations and adversarial examples are created with an objective of evading the NIDS detection mechanism. These can be generated by making subtle modifications to legitimate network traffic or by carefully crafting malicious traffic that fools the underlying ML/DL algorithms. These modifications, which include changing packet bytes or perturbing their timing/order, can exploit vulnerabilities in the NIDS, leading to false negative decisions. This can enable attackers to infiltrate networks undetected and disrupt operations.

To evaluate the robustness of the approach, the inventors crafted samples with multiple valid perturbations. Since the adversary's control in an evasion attack is limited to network packets sent from a single direction (i.e., the source), perturbations are applied to the forward network packets of each attack type. Adversarial examples are crafted, while preserving their communication functionality. Table 10 presents details on the perturbations, their corresponding values, and the specific packet bytes that were modified to maintain packet functionality. The inventors generated adversarial examples from the nine-sequential packets data set for each attack type using the above-mentioned perturbations. This disclosure presents two different perturbation use cases, among various others that the inventors examined. (i) an example in which half of the forward packets in each flow (containing nine sequential packets) were perturbed by applying all five perturbation methods on each of the selected packets. (ii) an example in which all the forward packets in each flow were perturbed using the five perturbation methods.

TABLE 10
Summary of the perturbation methods used for generating
adversial examples

| Perturbation | | |
|---|---|---|
| Method | Description | Affected Packet Bytes |
| Adding | Injecting 40 bytes of dead | It affects payload bytes |
| payload data | payload bytes such as 0xFF | and TCP checksum bytes |
| | at the end of the original | from the TCP header (byte |
| | packet payload. | number 17 and 18). |
| Changing | The delta time feature of | It only changes the |
| delta time | the selected packet in a | temporal relationship |
| | flow is increased by adding | between packets of a flow |
| | a delay, e.g., 0.001 ms. | and does not affect the |
| | | packet bytes. |
| Changing | Increasing or decreasing | It changes the following |
| window size | (+/−256) the window size | bytes from the TCP header: |
| | bytes. Any valid | window size bytes (byte |
| | perturbation to these bytes | number 15 and 16) and |
| | will result in a final | TCP checksum bytes (byte |
| | window size value between | number 17 and 18). |
| | 1-65535. | |
| Changing | Decreasing or increasing | It changes the following |
| time-to-live | (+/−1) the TTL of the | bytes from the IP header: |
| (TTL) | packets in the range of 0- | TTL byte (byte number 9) |
| | 255 (The range for TTL is | and IP checksum bytes |
| | from 0 to 255 and a | (byte number 11 and 12). |
| | recommended initial value | |
| | for TTL is 64 ). | |
| Modifying | Modifying the | It changes the following |
| fragmentation | fragmentation bytes from | bytes from the IP header: |
| | do not fragment to do | fragmentation bytes (byte |
| | fragment. This perturbation | number 7 and 8), TTL byte |
| | can be applied to packets | (byte number 9), and IP |
| | where fragmentation is | checksum bytes (byte |
| | turned off. | number 11 and 12). |

TABLE 11
Model performance against adversarial attacks

| | Percentage of forward packets perturbed | |
|---|---|---|
| | 50% | 100% |
| Attack | ER (%) | ER (%) |
| DoS Slowloris | 0 | 2.04 |
| DoS Slowhttptest | 0 | 0 |
| DoS Hulk | 2.04 | 2.04 |
| DoS GoldenEye | 0 | 0 |
| Heartbleed | 0 | 0 |
| FTP-Patator | 0 | 0 |
| SSH-Patator | 0 | 0 |
| Web Attack-Brute Force | 0 | 0 |
| Infiltration | 0 | 2.04 |
| PortScan | 0 | 2.04 |
| DDoS | 0 | 0 |

TABLE 12
Domain adaptability results using different image representations of
CIC-IDS2018 data

| Subset | Size | Accuracy | Precision | F1 | TNR | FNR | TPR | FPR |
|---|---|---|---|---|---|---|---|---|
| 1 | 230650 | 0.8207 | 0.9371 | 0.8171 | 0.9399 | 0.2756 | 0.7244 | 0.0601 |
| 2 | 185787 | 0.8462 | 0.9348 | 0.8034 | 0.9604 | 0.2956 | 0.7044 | 0.0396 |
| 3 | 178059 | 0.9004 | 0.9519 | 0.8725 | 0.9701 | 0.1946 | 0.8054 | 0.0299 |
| 4 | 175466 | 0.9524 | 0.9481 | 0.9432 | 0.9627 | 0.0617 | 0.9383 | 0.0373 |
| 5 | 174967 | 0.9625 | 0.9619 | 0.9549 | 0.9729 | 0.0519 | 0.9481 | 0.0271 |
| 6 | 174397 | 0.9687 | 0.9676 | 0.9624 | 0.9769 | 0.0427 | 0.9573 | 0.0231 |
| 7 | 171170 | 0.9719 | 0.9717 | 0.9669 | 0.9791 | 0.0379 | 0.9621 | 0.0209 |
| 8 | 169967 | 0.9743 | 0.9736 | 0.9699 | 0.9804 | 0.0339 | 0.9661 | 0.0196 |
| 9 | 160211 | 0.9744 | 0.9721 | 0.9677 | 0.9817 | 0.0368 | 0.9632 | 0.0183 |
| 10 | 158801 | 0.9740 | 0.9727 | 0.9671 | 0.9822 | 0.0385 | 0.9615 | 0.0178 |
| 11 | 140846 | 0.9746 | 0.9696 | 0.9627 | 0.9844 | 0.0442 | 0.9558 | 0.0156 |
| 12 | 136870 | 0.9742 | 0.9726 | 0.9622 | 0.9858 | 0.0480 | 0.9520 | 0.0142 |
| 13 | 130653 | 0.9750 | 0.9788 | 0.9649 | 0.9883 | 0.0487 | 0.9513 | 0.0117 |
| 14 | 121919 | 0.9737 | 0.9831 | 0.9652 | 0.9898 | 0.0520 | 0.9480 | 0.0102 |
| 15 | 107890 | 0.9724 | 0.9869 | 0.9675 | 0.9904 | 0.0511 | 0.9489 | 0.0096 |

TABLE 13
Detection analysis per attack type (CIC-IDS2018)

| Attack | Size | Accuracy | Precision | F1 | TNR | FNR | TPR | FPR |
|---|---|---|---|---|---|---|---|---|
| DoS | 6186 | 0.9510 | 0.9664 | 0.9505 | 0.9672 | 0.0650 | 0.9350 | 0.0328 |
| Slowloris | | | | | | | | |
| DOS | 36513 | 0.9714 | 0.9665 | 0.9699 | 0.9698 | 0.0267 | 0.9733 | 0.0302 |
| GoldenEye | | | | | | | | |
| SSH- | 84921 | 0.9782 | 0.9709 | 0.9782 | 0.9707 | 0.0143 | 0.9857 | 0.0293 |
| Patator | | | | | | | | |
| Web | 545 | 0.9450 | 0.9542 | 0.9434 | 0.9567 | 0.0672 | 0.9328 | 0.0433 |
| Attack- | | | | | | | | |
| Brute | | | | | | | | |
| Force | | | | | | | | |
| Web | 325 | 0.9508 | 0.9321 | 0.9497 | 0.9349 | 0.0321 | 0.9679 | 0.0651 |
| Attack- | | | | | | | | |
| XSS | | | | | | | | |
| Infiltration | 2181 | 0.9431 | 0.9616 | 0.9389 | 0.9668 | 0.0829 | 0.9171 | 0.0332 |

To compare the performance of the present approaches, the inventors tested the perturbed samples against the packet and flow-based NIDS used in recent literature studies, which included decision tree, random forest, support vector machine, k-nearest neighbor, and deep neural network models. The evasion rate (ER) against these ML/DL-based NIDS ranged from 70% to 99% across different attack types. In contrast, using the present approach, the ER of these samples was significantly reduced to a maximum of 2.04%, which was observed only for certain attack types, including DoS Slowloris, DoS Hulk, Infiltration, and Port Scan. Table 11 shows the results from the approach using the example SPIN-IDS framework for these two cases, demonstrating strong resilience against evasion attacks.

TABLE 14
Comparison of SPIN-IDS with baseline models using different
packet data representation

| | Performance Metrics | | | |
|---|---|---|---|---|
| Methods | Accuracy | Precision | Recall | F1 |
| RF | 0.9544 | 0.9435 | 0.9345 | 0.9356 |
| Adaboost | 0.8734 | 0.8435 | 0.8456 | 0.8432 |
| Classifier | | | | |
| MLP | 0.8323 | 0.8213 | 0.8045 | 0.8101 |
| DNN | 0.9021 | 0.8867 | 0.8935 | 0.8967 |
| 1D-CNN | 0.9563 | 0.9467 | 0.9332 | 0.9334 |
| SPIN-IDS | 0.9878 | 0.9877 | 0.9878 | 0.9878 |

Performance in a New Target Environment: To gauge the domain adaptability of the trained example model, the inventors conducted experiments using data from a new network environment. The experiment used CIC-IDS2018 data, which was processed using an example of the SPIN-IDS framework. First, the packet parser component extracted packet-based features from the pcap files, which was followed by the generation of images using the image builder component. These images were then passed through the network intrusion detector model, which was trained using CIC-IDS2017 image data. The experiments involved a similar setup as used with the CIC-IDS2017 data. Specifically, the experiments considered various image representations with different numbers of sequential packets extracted from the flows for evaluating the performance of the model. Table 12 presents the results from these experiments showing a similar performance of the trained example model on a new target network environment data set as observed on the source environment data set. The image representations with eight and nine sequential packets have the highest performance metric values among others, thereby strongly indicating that the malicious intent can be accurately detected early in a network communication. Table 13 shows the performance of the trained network intrusion detector in detecting images with nine sequential packets belonging to a sample set of network attack types in the CIC-IDS2018 data set. The results show that despite being trained only on the CIC-IDS2017 image data set, the model was able to achieve a good performance in detecting attacks in a different environment. The approach using the example SPIN-IDS framework has shown that the network intrusion detection model can perform well on data from a different target environment without the need to retrain and hence, reinforcing its potential as an effective intrusion detection tool for cybersecurity operations centers.

Performance Comparison with Other Approaches: An advantage of the presently-disclosed embodiments is the highly accurate detection of malicious network traffic; in (near-) real-time; by examining a minimal number of packets within ongoing traffic flows. This section first demonstrates the efficacy of the approaches described herein using an RGB image data representation implementation, compared against other baseline models, using the numerical data in a flat format representation. Subsequently, the approaches described herein are compared with state-of-the-art NIDS from the literature that uses packet information.

Significant Improvement Over Baseline Models: The inventors conducted experiments to compare the performance of the present approaches against several baseline models using packet-based data from the CIC-IDS2017 data set. Extracting nine packets sequentially from each flow, they packets were concatenated and utilized in a flat format for the baseline models. The choice of these models and their hyperparameters was informed by their widespread adoption and established effectiveness in the literature. In particular, the inventors developed the following models: Random Forest (RF), Adaboost Classifier, Multilayer Perceptron (MLP), a five-layer DNN model, and a 1D-CNN model with four layers. The inventors then compared their performance against that of the approach using the image-based packet data representation of the same flows.

Table 10 presents the results obtained for all the models. Notably, SPIN-IDS outperforms the other baseline models across all evaluated metrics. It can be observed that, in the context of packet-based network traffic with a significantly large feature space dimension, the 1D-CNN model performs nearly as well as the RF model. However, the notable fact that SPIN-IDS surpasses the 1D-CNN model by over 5% in terms of the F1 score underscores the efficacy of providing RGB image formats for network traffic in detecting the underlying attack patterns.

TABLE 15
Comparison of embodiments according to the present disclosure, with
other packet-based NIDS approaches:

| | Performance Metrics | | | | | |
|---|---|---|---|---|---|---|
| | | | | | Training | Testing |
| Methods | Accuracy | Precision | Recall | F1 | Time | Time |
| PL-RNN | 0.6825 | 0.8335 | 0.5638 | 0.6934 | 720000 | 2.91 |
| Packet2Vec | 0.6625 | 0.8435 | 0.7284 | 0.6273 | 515000 | 3.54 |
| HAST-II | 0.6423 | 0.8856 | 0.6898 | 0.7498 | 676000 | 4.2 |
| AEIDS | 0.7736 | 0.6325 | 0.5872 | 0.6182 | 275800 | 2.65 |
| Payload | 0.9538 | 0.9536 | 0.9535 | 0.9534 | 355000 | 2.73 |
| Embeddings | | | | | | |
| PBCNN | 0.9821 | 0.9831 | 0.983 | 0.9835 | 368000 | 7.89 |
| Present | 0.9878 | 0.9877 | 0.9878 | 0.9878 | 314800 | 1.04 |
| Invention | | | | | | |

Significant Improvement in Operation, Accuracy, and Capability versus Other NIDS Approaches: The inventors then compared the results obtained using the approaches described herein with other existing methods in the literature that leveraged packet information in their proposed NIDS. Table 15 presents a performance comparison of the approach against DL-based models from the literature using the same data set (CIC-IDS2017) and key performance metrics, specifically, AEIDS, HAST-II, PL-RNN, Packet2Vec, PayloadEmbeddings, and PBCNN. The table provides information on each model's total training time and testing (inference) time per unit in milliseconds (ms). Here, a unit represents either a packet or an image, based on the data format used in the respective method. Notably, for a more precise analysis, the inventors even incorporated the average image generation time along with the inference time for each image in the approach. The image generation process took an average of 0.92 ms for each image representation, considering packet sequences ranging from one to 15 packets. The total testing time, including both image generation and model's inference time, was recorded at 1.04 ms. As depicted in the table, embodiments that operate according to the present disclosure demonstrate superior performance in terms of performance metric values and testing time compared to other methods. The improvement in performance is clear from the data. Other improvements are also achieved as well, which may not directly reflect in performance but bear on things like computational efficiency. As an example, in PBCNN, the authors utilized a sequence of 20 packets for their threat detection model, while SPIN-IDS achieves better results using only nine packets (and thus significantly less computational cost). The embodiments disclosed herein outperform the others in terms of inference time (speed to make an assessment), in part due to the significantly fewer parameters in the network intrusion detector model architecture within the framework and approach disclosed herein.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A method for detecting malicious activity in a network communication system, the method comprising:
receiving a first packet of a first flow from the network communication system, the first packet comprising a first sequence of data values;
converting the first sequence of data values to a first plurality of pixel image attribute values;
generating a first portion of an image based on the first plurality of pixel image attribute values; and
processing the image using a trained neural network model to determine a likelihood of malicious activity in the first flow.

2. The method of claim 1, further comprising generating a notification indicating that malicious activity has been detected.

3. The method of claim 1, further comprising:
determining if there are additional packets in the first flow;
receiving a second packet of the first flow from the network communication system, the second packet comprising a second sequence of data values;
converting the second sequence of data values to a second plurality of pixel image attribute values;
generating a second portion of the image based on the second plurality of pixel image attribute values; and
processing the image using the trained neural network model to determine an updated likelihood of malicious activity in the first flow.

4. The method of claim 3, wherein:
the first plurality of pixel image attribute values is a first plurality of one color channel of red-green-blue (RGB) values; and
the second plurality of pixel image attribute values is a second plurality of one color channel of RGB values, different from the first color channel.

5. The method of claim 1, wherein the first packet from the network communication system is an incoming packet.

6. The method of claim 3, wherein the second packet from the network communication system is an outgoing packet.

7. The method of claim 1, wherein the first sequence of data values comprises at least one hexadecimal byte value.

8. The method of claim 7, wherein converting the first sequence of data values to the first plurality of pixel image attribute values comprises:
converting the at least one hexadecimal byte value to at least one decimal value; and
assigning a corresponding color scale value to the at least one decimal value.

9. A system for detecting malicious activity in a network communication system, the system comprising:
one or more processors;
a memory in communication with the processor and having instructions stored thereon that, when executed, cause the processor to:
receive a first packet of a first flow from the network communication system, the first packet comprising a first sequence of data values;
convert the first sequence of data values to a first plurality of pixel image attribute values;
generate a first portion of an image based on the first plurality of pixel image attribute values; and
process the image using a trained neural network model to determine a likelihood of malicious activity in the first flow.
